(19) United States
(12) Patent Application Publication
(10) Pub. No.: US 2020/0226685 A1
(43) Pub. Date: Jul. 16, 2020

(54) SYSTEMS AND METHODS FOR CHANGE IN LANGUAGE-BASED TEXTUAL ANALYSIS

(71) Applicant: JPMorgan Chase Bank, N.A., New York, NY (US)

(72) Inventors: Phil Hart, New York, NY (US); Jonathan Tse, New York, NY (US); Santosh Khot, Edison, NJ (US); Dan Zheng, New Malden (GB); Manan Patel, Edison, NJ (US); Wonseok Choi, Edgewater, NJ (US); Haoran Zhao, Greenwich, CT (US); Dennis S. Ruhl, New York, NY (US); Eric Moreau, Long Island City, NY (US)

(21) Appl. No.: 16/248,089

(22) Filed: Jan. 15, 2019

(51) Int. Cl. G06Q 40/06; G06F 17/22; G06F 17/27; G06Q 10/04; G06F 16/93

(52) U.S. Cl. CPC G06Q 40/06; G06F 17/2211; G06F 16/93; G06Q 10/04; G06F 17/27

(57) ABSTRACT

Systems and methods for change in language-based textual analysis are disclosed. In one embodiment, in an information processing apparatus comprising at least one computer processor, a method for change in language-based textual analysis may include: (1) retrieving, from a data source, a first document of a first type; (2) retrieving, from the data source, a second document of the first type, the second document being subsequent in time to the first document; (3) identifying changes between the first document and the second document; (4) calculating a change score based on the changes; and (5) providing the change score to a downstream system for projecting a performance of an investment associated with the first document.

### BACKGROUND OF THE INVENTION

### 1. Field of the Invention

The present invention generally relates to systems and methods for change in language-based textual analysis.

### 2. Description of the Related Art

In finance and accounting, relative to quantitative methods traditionally used, textual analysis has become popular recently. Company SEC filings and 10-K and 10-Q forms have disclosures for risks or challenges that the company management feels obligated to disclose.

### SUMMARY OF THE INVENTION

Systems and methods for change in language-based textual analysis are disclosed. In one embodiment, in an information processing apparatus comprising at least one computer processor, a method for change in language-based textual analysis may include: (1) retrieving, from a data source, a first document of a first type; (2) retrieving, from the data source, a second document of the first type, the second document being subsequent in time to the first document; (3) identifying changes between the first document and the second document; (4) calculating a change score based on the changes; and (5) providing the change score to a downstream system for projecting a performance of an investment associated with the first document.

In one embodiment, the data source may be a government agency.

In one embodiment, the first type may be a company security filing. The company security filing may be 10K or a 10Q.

In one embodiment, the first type may include a research report or a company call transcript.

In one embodiment, the changes between the first document and the second document may be identified by: removing at least one of common characters and common words from each of the first document and the second document; transforming the first document into a first list of words; transforming the second document into a second list of words; and identifying the changes as the difference between the first list of words and the second list of words.

In one embodiment, the method may further include determining a sentiment change based on the changes.

In one embodiment, the change score may be based on a ratio of an amount of the changes to an amount of content in the second document.

In one embodiment, a low change score may indicate future underperformance of the investment, and a high change score may indicate future overperformance of the investment.

In one embodiment, the downstream systems may include at least one of a signal construction system, a portfolio optimization system, a reporting system, and a quantitative research system.

According to another embodiment, in an information processing apparatus comprising at least one computer processor, a method for change in language-based textual analysis may include: (1) retrieving, from a data source, a first document of a first type; (2) retrieving, from the data source, a second document of the first type, the second document being subsequent in time to the first document; (3) identifying changes between the first document and the second document; (4) calculating a change score based on the changes; (5) presenting the first document and the second document with the changes identified; (6) receiving a selection of a change in the first document or the second document to disregard, or a modification to the first document or the second document; (7) identifying hypothetical changes between the first document or the second document with the selected change disregard, or the modified first document or the second document, and the first document or the second document; (8) receiving a selection of the change score or the hypothetical change score; and (9) providing the change score or the hypothetical change score to a downstream system for projecting a performance of an investment associated with the first document.

In one embodiment, the data source may be a government agency.

In one embodiment, the first type may be a company security filing. The company security filing may be 10K or a 10Q.

In one embodiment, the changes between the first document and the second document may be identified by: removing at least one of common characters and common words from each of the first document and the second document; transforming the first document into a first list of words; transforming the second document into a second list of words; and identifying the changes as the difference between the first list of words and the second list of words.

In one embodiment, the hypothetical changes between the first document or the second document with the selected change disregard, or the modified first document or the second document, and the first document or the second document may be identified by: removing at least one of common characters and common words from each of the first document or the second document with the selected change disregard, or the modified first document or the second document, and the first document or the second document; transforming the first document or the second document with the selected change disregard, or the modified first document or the second document into a third list of words; transforming the first document or the second document into a fourth list of words; and identifying the hypothetical changes as the difference between the third list of words and the fourth list of words.

In one embodiment, the method may further include determining a sentiment change based on the hypothetical changes.

In one embodiment, the hypothetical change score may be based on a ratio of an amount of the hypothetical changes to an amount of content in the first document or the second document.

In one embodiment, a low hypothetical change score may indicate future underperformance of the investment, and a high hypothetical change score may indicate future overperformance of the investment.

In one embodiment, the downstream systems may include at least one of a signal construction system, a portfolio optimization system, a reporting system, and a quantitative research system.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for change in language-based textual analysis according to one embodiment;

FIG. 2 depicts an method for change in language-based textual analysis according to one embodiment; and

FIG. 3 depicts a “what if” change in language-based textual analysis according to one embodiment.

### DETAILED DESCRIPTION OF PREFERRED EMBODIMENTS

Embodiments disclosed herein are directed to systems and methods for change in language-based textual analysis.

In general, unless company management has to disclose potentially negative information in order to avoid future litigation by investors, company management is reluctant to materially change the content of these filings. Thus, a material change in company filings tends to be associated with future underperformance of stocks, and a small change tends to be associated with future outperformance.

Embodiments disclosed herein direct the generation of a signal, such as a change in language signal, that may represent an amount of change between company filings.

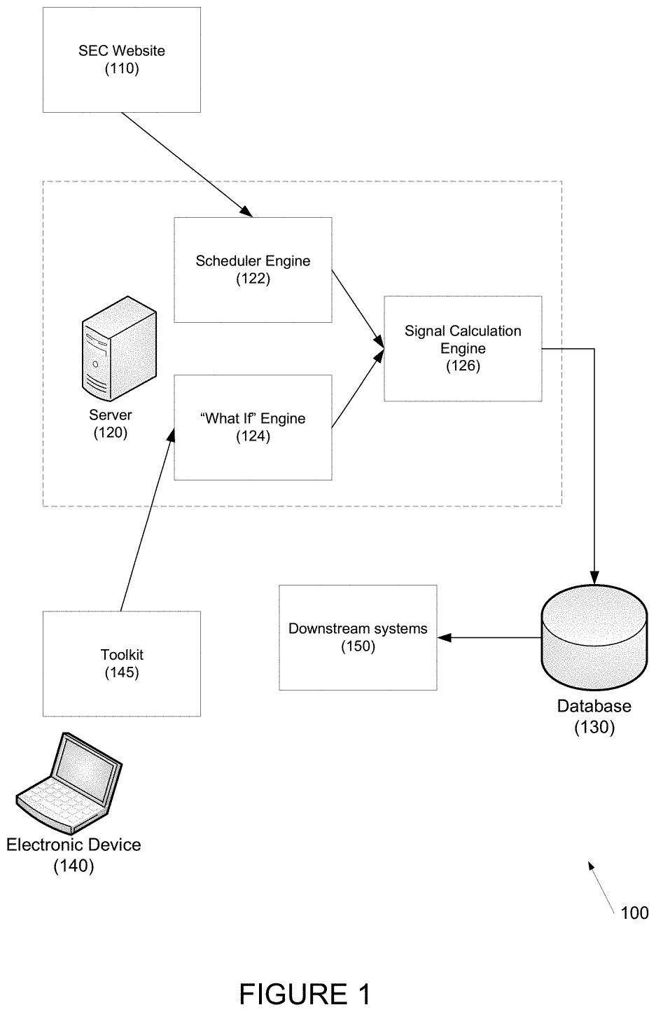

Referring to FIG. 1, a system for change in language-based textual analysis is disclosed according to one embodiment. System 100 may include document source 110, such as the SEC website, from which company documents (e.g., 10K, 10Q, other SEC filings) may be retrieved. Other sources of documents, and document types (e.g., company conference call transcripts, internal/external research reports, etc.), may be included as is necessary and/or desired.

In one embodiment, a current document and a prior document may be retrieved from document source 110. In another embodiment, a current document may be retrieved from document source 110, and a prior document may be retrieved from a local database, third party, etc.

System 100 may include server 120, which may host or execute scheduler engine 122, “what if” engine 124, and signal calculation engine 126. Scheduler engine 122 may perform a process whereby forms are downloaded from document source 110, content is extracted, and the content is processed using, for example, natural language processing, machine learning, etc. to identify changes from the prior document to the current document.

In one embodiment, changes in sentiment may be identified.

Scheduler engine 124 may provide the changes to score calculation engine 126, which may generate a change score based on the identified changes, and may generate a change score signal for the change score. For example, the value of the change score signal may range from 0.0 to 1.0, with 0.0 indicating a large change and an expected future underperformance, and 1.0 indicating a smaller change and an expected future outperformance. This change score may be provided to downstream systems 150, which may be used to calculate an expected relative performance of each stock.

In one embodiment, scheduler engine 124 may run as a daily process, may be run on-demand, or may be run as otherwise is necessary and/or desired.

“What if” engine 124 may allow hypotheticals to be run against the forms received. In one embodiment, “what if” engine 124 may allow a user to select changes in documents to disregard. “What if” engine 124 may also permit users to introduce and/or add changes, make modifications to the forms, etc. as is necessary and/or desired.

In one embodiment, “what if” engine 124 may present the forms being compared to each other with changes identified by, for example, highlighting, using different colors, different fonts, bubbles, etc.

Score calculation engine 126 may then calculate a hypothetical, or “what if,” change score based on the comparison with the disregarded changes and/or modifications, and may generate a signal reflecting the hypothetical change score.

In one embodiment, a user may access “what if” engine 124 using toolkit 145, which may be a computer program or application executed by electronic device 140. Electronic device 140 may be any suitable electronic device, including desktop computers, notebook computers, tablet computers, Internet of Things (“IoT”) devices, etc.

Database 130 may store the change score signal generated by signal calculation engine 126, and may provide the signal to downstream systems 150, such as a portfolio construction process. Examples of downstream systems 150 include signal construction systems, portfolio optimization systems, reporting systems, quantitative research systems, etc. Downstream systems 150 may be used, for example, by portfolio managers, fundamental research analysts and quantitative research analysts. Some or all of these systems are automated.

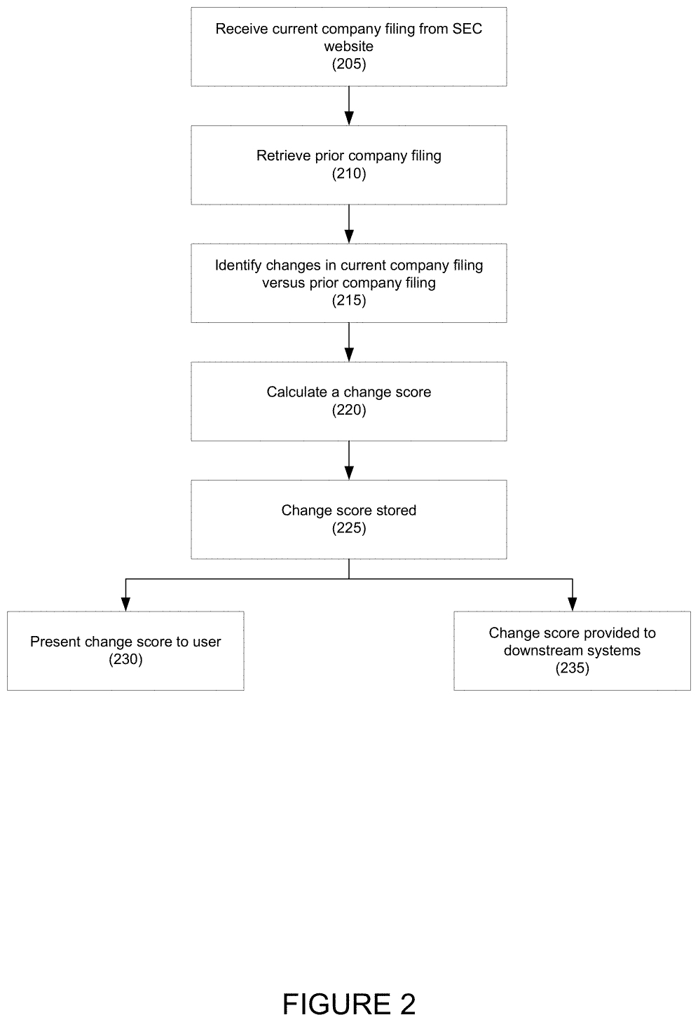

Referring to FIG. 2, a method for change in language-based textual analysis is disclosed according to one embodiment.

In step 205, a current company filing may be retrieved from a document source, such as the SEC website. For example, a company's current 10K, 10Q, or other SEC filings may be retrieved. Other document sources and document types may be used as is necessary and/or desired.

In step 210, a prior company filing of the same type as retrieved in step 205 may be retrieved. In one embodiment, the prior company filing may be retrieved from the document source (e.g., the SEC website), or it may be retrieved from a database if the prior filing has been stored locally or with a third party.

In step 215, changes in the current document may be identified. In one embodiment, the changes may be identified using, for example, a text comparison tool. In one embodiment, the documents may be compared by transforming each document into a list of words. For example, an algorithm may first review each document to remove characters, words, fields, and/or sections that may be deemed too common and irrelevant for the change comparison. The documents may then be transformed into word lists, and the similarity between the two word lists represents the similarity between the two documents.

In another embodiment, a sentiment analysis may be performed to identify a change in sentiment.

In step 220, a change score may be calculated based on the changes identified in step 215. In one embodiment, the change score may represent the similarity between documents, such that a high change score indicates few changes, and a low change score indicates many changes. For example, the score may be given in a range from 0.0 (e.g., very different) to 1.0 (e.g., very similar); other scoring mechanisms may be used as is necessary and/or desired.

In step 225, the change score may be stored in a database.

In step 230, the change score may be presented to a user. For example, the score may be shown in conjunction with the source texts, the changes, as well as other related information about the source texts.

In step 230, the change score may be stored in a database.

In step 235, the change score may be provided to one or more downstream system. Examples of downstream systems include signal construction systems, portfolio optimization systems, reporting systems, quantitative research systems. Downstream systems 150 may be used, for example, by portfolio managers, fundamental research analysts and quantitative research analysts.

In one embodiment, steps 230 and 235 may be performed in parallel, sequentially, etc.

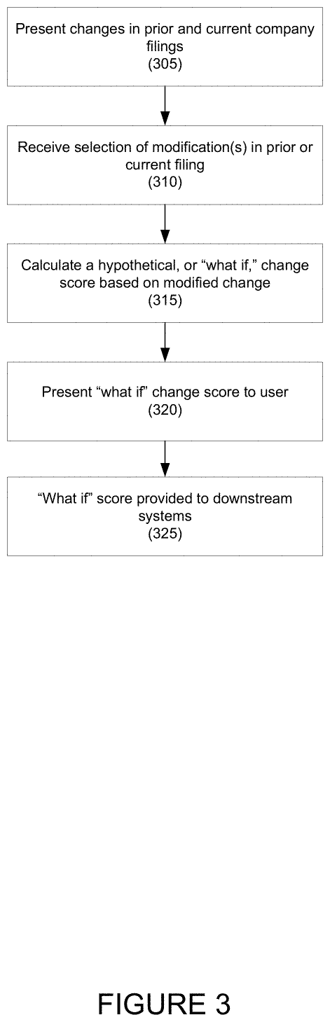

Referring to FIG. 3, a method for “what if” change in language-based textual analysis is disclosed according to one embodiment.

In step 305, the changes in the prior document and the current document may be presented in, for example, a user interface. In one embodiment, the changes may be highlighted or otherwise identified for the user.

In step 310, the user may select one or more change to modify or disregard. In one embodiment, the change may be in the prior document or in the current document. The user may select the change in any suitable manner, such as clicking on the highlighted or otherwise identified change.

In step 315, based on the modified or disregarded changes, a hypothetical, or “what if,” change score may be calculated. The “what if” change score may be calculated in the same or similar matter as discussed above.

In step 320, the “what if” change score may be stored in a database. For example, a user may store multiple “what if” scenarios, comments, etc.

In step 325, the “what if” change score may be provided to one or more downstream system, such as a portfolio build process. In one embodiment, the user may select the score (e.g., the actual change score, one of the “what if” change score) to use.

It should be recognized that although several embodiments have been disclosed, these embodiments are not exclusive and aspects of one embodiment may be applicable to other embodiments.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, from automated scheduling, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, Phyton, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for change in language-based textual analysis, comprising:
in an information processing apparatus comprising at least one computer processor:
interfacing with a website to automatically retrieve a plurality of documents;
retrieving, from the website, a first document of a first type;
retrieving, from the website, a second document of the first type, the second document being subsequent in time to the first document;
identifying changes between the first document and the second document;
calculating a change score based on the changes, the change score quantifying the degree of change between the first document and the second document; and
providing the change score to a downstream system, the downstream system configured to project a performance of an investment associated with the first document in response to receiving the change score.

2. The method of claim 1, wherein the website is a data source of a government agency.

3. The method of claim 1, wherein the first type is a company security filing.

4. The method of claim 3, wherein the company security filing is a Securities and Exchange Commission (SEC) 10K filing or a SEC 10Q filing.

5. The method of claim 1, wherein the first type is a research report or a company call transcript.

6. The method of claim 1, wherein the changes between the first document and the second document are identified by:
removing at least one of common characters and common words from each of the first document and the second document;
transforming the first document into a first list of words;
transforming the second document into a second list of words; and
identifying the changes as the difference between the first list of words and the second list of words.

7. (canceled)

8. The method of claim 1, wherein the degree of change is based on a ratio of an amount of the changes to an amount of content in the second document.

9. The method of claim 1, wherein a low change score indicates future underperformance of the investment, and a high change score indicates future overperformance of the investment.

10. The method of claim 1, wherein the downstream systems include at least one of a signal construction system, a portfolio optimization system, a reporting system, and a quantitative research system.

11. A method for change in language-based textual analysis, comprising:
in an information processing apparatus comprising at least one computer processor:
executing a scheduler to retrieve a plurality of documents from a data source according to automated scheduling;
retrieving, from the data source, a first document of a first type;
retrieving, from the data source, a second document of the first type, the second document being subsequent in time to the first document;
identifying changes between the first document and the second document;
calculating a change score based on the changes;
presenting the first document and the second document with the changes identified;
receiving a selection of a change in the first document or the second document to disregard, or a modification to the first document or the second document;
identifying hypothetical changes between the first document or the second document with the selected change disregard, or the modified first document or the second document, and the first document or the second document;
receiving a selection of the change score or the hypothetical change score; and
providing the change score or the hypothetical change score to a downstream system, the downstream system configured to project a performance of an investment associated with the first document in response to receiving the change score or the hypothetical change score.

12. The method of claim 11, wherein the data source is a website of a government agency.

13. The method of claim 11, wherein the first type is a company security filing.

14. The method of claim 13, wherein the company security filing is a Securities and Exchange Commission (SEC) 10K filing or a SEC 10Q filing.

15. The method of claim 11, wherein the changes between the first document and the second document are identified by:
removing at least one of common characters and common words from each of the first document and the second document;
transforming the first document into a first list of words;
transforming the second first document into a second list of words; and
identifying the changes as the difference between the first list of words and the second list of words.

16. The method of claim 11, wherein the hypothetical changes between the first document or the second document with the selected change disregard, or the modified first document or the second document, and the first document or the second document are identified by:
removing at least one of common characters and common words from each of the first document or the second document with the selected change disregard, or the modified first document or the second document, and the first document or the second document;
transforming the first document or the second document with the selected change disregard, or the modified first document or the second document into a third list of words;
transforming the first document or the second document into a fourth list of words; and
identifying the hypothetical changes as the difference between the third list of words and the fourth list of words.

17. (canceled)

18. The method of claim 11, wherein the hypothetical change score is based on a ratio of an amount of the hypothetical changes to an amount of content in the first document or the second document.

19. The method of claim 11, wherein a low hypothetical change score indicates future underperformance of the investment, and a high hypothetical change score indicates future overperformance of the investment.

20. The method of claim 11, wherein the downstream systems include at least one of a signal construction system, a portfolio optimization system, a reporting system, and a quantitative research system.
